(19) United States
(12) Patent Application Publication
(10) Pub. No.: US 2024/0036901 A1
(43) Pub. Date: Feb. 1, 2024

(54) CONTAINER IMAGE MANAGEMENT

(71) Applicant: Red Hat, Inc., Raleigh, NC (US)

(72) Inventor: Giuseppe Scrivano, Spezzano della Sila (IT)

(21) Appl. No.: 17/873,860

(22) Filed: Jul. 26, 2022

(51) Int. Cl. G06F 9/455

(52) U.S. Cl. CPC G06F 9/45558; G06F 2009/45583

(57) ABSTRACT

Implementations of the disclosure provide a method including calculating, by a processing device, a time required to have a container image ready for use; determining whether the time satisfies a threshold criterion; and responsive to determining that the time satisfies the threshold criterion, performing a synchronization operation that stores the container image in a persistent storage.

### TECHNICAL FIELD

The implementations of the disclosure relate generally to computing infrastructures and, more specifically, relate to container image management.

### BACKGROUND

Containerization is an operating-system-level virtualization environment for running multiple isolated system containers on a single host machine. It is an alternative to full machine virtualization that involves encapsulating a process into a container with its own operating environment. Each virtual container may share the kernel of the underlying operating system without requiring its own kernel. Avoiding separate kernels for each container may reduce computational overhead.

### BRIEF DESCRIPTION OF THE DRAWINGS

The disclosure is illustrated by way of examples, and not by way of limitation, and may be more fully understood with references to the following detailed description when considered in connection with the figures, in which:

FIG. 1 depicts a block diagram of a computing system in which implementations of the present disclosure may operate.

FIG. 2 depicts a block diagram of a system architecture in which implementations of the present disclosure may operate.

FIG. 3 depicts a block diagram of a detailed view of a computer system implementing a container management component or a manager according to an implementation of the present disclosure.

FIGS. 4 and 5 depict flow diagrams of methods of adaptive performing a synchronization operation that saves a container image to a persistent storage according to an implementation of the present disclosure.

FIG. 6 depicts a block diagram of an example computer system in accordance with one or more aspects of the present disclosure.

FIG. 7 depicts a block diagram illustrating a computer system in which implementations of the disclosure may be used.

### DETAILED DESCRIPTION

Systems and methods of the present disclosure are directed to container image management. Containers are used in various types of systems to provide a secure environment that is isolated from other processes on the system. For example, an application may be executed in a container that provides a self-contained secure process space in the system, and a system using containers may provide data associated with different applications to a plurality of clients. The data used for the execution of applications can include an image built from pre-existing application components and source code of the application, and the image may be referred to as container image.

A container image may refer to data representing executables and files of the application used to deploy functionality for a runtime instance of the application. In one implementation, the image can be built using a particular tool, such as Docker™ tool, and is also referred to as a Docker image. The tool generates an image for an application by combining pre-existing ready-to-run image corresponding to core functional components of the application (e.g., a web framework, database, etc.) with source code specific to the application. The resulting application image may be stored in an image repository (e.g., data storage system) for subsequent use in launching instances of the application images for execution in remote use.

There are, however, several issues that can occur due to the storage of container images. For example, when a new container image is created or pulled in memory, its files and metadata cannot be considered fully present in a persistent storage unless a synchronization operation (e.g., syncfs( )) is performed that would store the files and metadata in a persistent storage. Such synchronization operation is performed in order to compensate, e.g., for a browser's failure to expose a synchronous application programming interface (API) for storing files in the persistent storage. However, synchronization operations can involve multiple input/output (I/O) operations and cause problems. For example, when running in a cloud environment or multiple container images being processed, the storage access operations can be throttled, causing the system to freeze temporarily. In such cases, the storage access operation associated with a container can also affect other processes and containers that are accessing the same file system. Various existing implementations do not provide an adaptive way of determining whether a container image should be stored in a persistent storage.

Aspects of the present disclosure address the above and other deficiencies by selectively saving container images in a persistent storage. In one example, when a container image is built or retrieved for use, which means that the data of the container image has been loaded in the memory, a controller may record the entire time for the container image getting ready for use. The technology may calculate the time required to have the container image ready for use (“ready-time”) and compare it with a threshold criterion, such as a threshold value, to determine whether to perform a synchronization operation that stores the container image in a persistent storage. The threshold criterion can be chosen to ensure that the synchronization operation is performed if the ready-time is long enough that it is worth to save the container image in the persistent storage for a later use, thus avoiding the synchronization operation which would take more time than building the container image or retrieving the container image from an image repository. It would also make sure that an expensive container image, which takes long ready-time, would be saved in the persistent storage so that it would not get lost in an event of an unclean shutdown.

The technology may also use various threshold criteria, such as a criterion ascertaining whether the container image is built locally with respect to the container engine or retrieved remotely. For example, the synchronization operation that stores the container image in the persistent storage may be triggered if an indication is included in the data of the ready-time indicating the container image is built rather than retrieved. In another example, the synchronization operation that stores the container image in the persistent storage may be triggered if an indication is included in the data of the ready time indicating the container image contains customized element(s). This would benefit in making a class of container images saved in a persistent storage, which is worth than other classes of container images to be saved in the persistent storage.

The systems and methods described herein enhance virtualization technology for a computer system. In particular, aspects of the present disclosure may enable storage optimization of container images. Aspects of the present disclosure may also reduce the computing resources consumed by the containerized services by optimizing the persistent storage of the container images, including storage resources (e.g., disk and memory space), processing resources (e.g., processor cycles), Input Output (I/O) resources, other computing resources, or a combination thereof. The technology may also permit different container engines (e.g., Podman and CRI-O) to share the storage with different policies for persisting images.

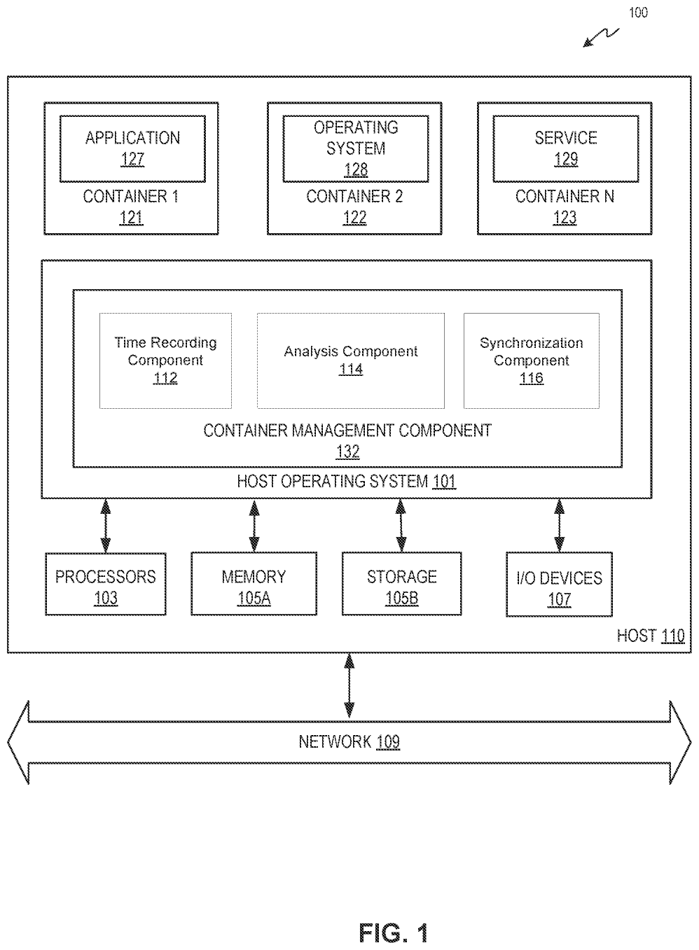

FIG. 1 is a block diagram that illustrates an embodiment of a computer system 100 in which embodiments of the present invention may operate. The computer system 100 may include a host 110. The host 110 may be a server, a workstation, a personal computer (PC), a mobile phone, a personal digital assistant (PDA), or any other suitable computing device. The host 110 may run an operating system (OS) 101 to manage its resources, such as one or more processors 103 communicatively coupled to memory devices 105A-B, and I/O devices 107. The host 110 may run one or more processes. Each of the processes may be a program or a thread of a multi-threaded program. Each of the processes may be a user-space process or a system-level process. Further, each of the processes may run on the host 110 or on a virtual machine hosted by the host 110.

Examples of processors 103 (also referred herein as “processing devices” or CPUs) include various devices that are capable of executing instructions encoding arithmetic, logical, or I/O operations. In an illustrative example, a processor may follow Von Neumann architectural model and may include an arithmetic logic unit (ALU), a control unit, and a plurality of registers. In another aspect, a processor may be a single core processor which is capable of executing one instruction at a time (or process a single pipeline of instructions), or a multi-core processor which may simultaneously execute multiple instructions. In another aspect, a processor may be implemented as a single integrated circuit, two or more integrated circuits, or may be a component of a multi-chip module (e.g., in which individual microprocessor dies are included in a single integrated circuit package and hence share a single socket). Examples of I/O device 107 include devices providing an interface between a processor and an external device capable of inputting and/or outputting binary data.

Examples of memory devices 105A-B include volatile or non-volatile memory devices, such as RAM, ROM, EEPROM, or any other devices capable of storing data. In the example as shown in FIG. 1, memory 105A includes volatile memory devices as temporary storage, and storage 105 includes non-volatile memory devices as persistent storage.

In some embodiments, the computer system 100 may be accessible by remote systems via a network 109. The network 109 may be a private network (e.g., a local area network (LAN), a wide area network (WAN), intranet, etc.) or a public network (e.g., the Internet).

The host 110 may include an operating system 101 with one or more user space programs. The operating system may be any program or combination of programs that are capable of using the underlying computing device to perform computing tasks. The operating system may include a kernel comprising one or more kernel space programs (e.g., memory driver, network driver, file system driver) for interacting with virtual hardware devices or actual hardware devices (e.g., para-virtualization). User space programs may include programs that are capable of being executed by the operating system and in one example may be an application program for interacting with a user. The host 110 may comprise a computing device, and may refer to the computing device (e.g., physical machine), a virtual machine, or a combination thereof.

The host 110 may provide one or more levels of virtualization such as hardware-level virtualization, operating system level virtualization, other virtualization, or a combination thereof. The host 110 may provide hardware-level virtualization by running a hypervisor that provides hardware resources to one or more virtual machines. The hypervisor may be any program or combination of programs and may run on a host operating system or may run directly on the hardware (e.g., bare-metal hypervisor). The hypervisor may manage and monitor various aspects of the operation of the computing device, including the storage, memory, and network interfaces. The hypervisor may abstract the physical layer features such as processors, memory, and I/O devices, and present this abstraction as virtual devices to a virtual machine.

The host 110 (e.g., physical machine or virtual machine) may also or alternatively provide operating system level virtualization by running a computer program that provides computing resources to one or more containers 121, 122, 123. Operating system level virtualization may be implemented within the kernel of the operating system and may enable the existence of multiple isolated containers. In one example, operating system level virtualization may not require hardware support and may impose little to no overhead because programs within each of the containers may use the system calls of the same underlying operating system. This enables the host 110 to provide virtualization without the need to provide hardware emulation or be run in an intermediate virtual machine as may occur with hardware-level virtualization.

Operating system level virtualization may provide resource management features that isolate or limit the impact of one container (e.g., container 121) on the resources of another container (e.g., container 122 or 123). The operating system level virtualization may provide a pool of resources that are accessible by container 121 and are isolated from one or more other containers (e.g., container 122). The pool of resources may include file system resources (e.g., particular volume), network resources (e.g., particular network address), memory resources (e.g., particular memory portions), other computing resources, or a combination thereof. The operating system level virtualization may also limit a container's access to one or more computing resources by monitoring the containers activity and restricting the activity in view of one or more limits (e.g., quotas). The limits may restrict the rate of the activity, the aggregate amount of the activity, or a combination thereof. The limits may include one or more of disk limits, input/out (I/O) limits, memory limits, CPU limits, network limits, other limits, or a combination thereof.

In one example, an operating system virtualizer provides the computing resources to containers 121, 122, 123. The operating system virtualizer may wrap an application in a complete file system that contains the code, runtime, system tools, system libraries and other programs installed on the host that can be used by the application. In one example, the operating system virtualizer may be the same or similar to Docker for Linux®, ThinApp® by VMWare®, Solaris Zones® by Oracle®, or other program that automates the packaging, deployment, and execution of applications inside containers.

Each of the containers 121, 122, 123 may refer to a resource-constrained process space of the host 110 that can execute functionality of a program. Containers 224A-C may be referred to as a user-space instances, a virtualization engines (VE), or jails and may appear to a user as a standalone instance of the user space of an operating system. Each of the containers 121, 122, 123 may share the same kernel but may be constrained to only use a defined set of computing resources (e.g., CPU, memory, I/O). Data structures may be used to organize one or more containers 125A-C and enhance sharing between containers, which may reduce the level of isolation between containers within the same group. In some implementations, the containers 121, 122, 123 may include installations of various operating systems (e.g., operation system 128).

Each of the containers 121, 122, 123 may host a framework or provide other functionality of a service (e.g., web application functionality, database functionality) or application, which may be any combination of software products that may perform a desired function. In some cases, a service or an application may be a single software program that operates with a hardware platform. Some service or application may use multiple software components, each of which may be written in a number of different programing languages and may execute a plurality of different application processes on the hardware platform. The containers may therefore be referred to as “service containers” or “application containers.” In some implementations, the containers 121, 122, 123 may include various applications (e.g., application 127) and/or various services (e.g., service 129).

As illustrated in FIG. 1, the host 110 may include a container management component 132 that can manage containers hosted on the computer system 100 (e.g., containers 121, 122, 123). In one implementation, the container management component 132 may be part of host operating system 101. In another implementation, the container management component 132 may be implemented as a program that is not part of host operating system 101.

The container management component 132 may manage containers corresponding to various operating systems, applications, and/or services. In some embodiments, the container management component 132 may include a time recording component 112, an analysis component 114, and a synchronization component 116. Time recording component 112 may calculate the time required to have a container image ready for use. Analysis component 114 may determine whether the time satisfies a threshold criterion. Synchronization component 116 may perform a synchronization operation or prevent a synchronization operation for the container image identified by the determination of whether the time satisfies a threshold criterion.

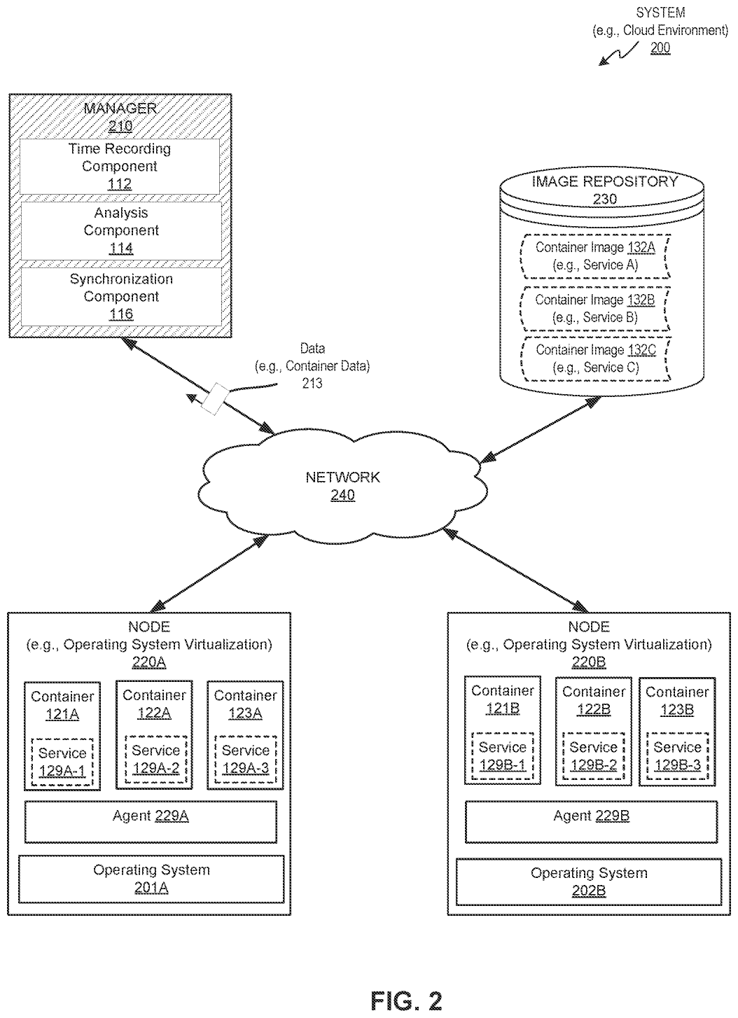

FIG. 2 illustrates an example system 200 in which implementations of the disclosure may operate. The system 200 may include a manager 210, a plurality of nodes 220A, 220B, and an image repository 230 coupled via a network 240. The system 200 provides a platform and environment that allow users to access applications and services in a clustered compute environment (the “cloud”). Although implementations of the disclosure are described in accordance with a certain type of system, this should not be considered as limiting the scope or usefulness of the features of the disclosure.

Network 240 may be a public network (e.g., the internet), a private network (e.g., a local area network (LAN) or wide area network (WAN)), or a combination thereof. In one example, network 140 may include a wired or a wireless infrastructure, which may be provided by one or more wireless communications systems, such as a wireless fidelity (WiFi) hotspot connected with the network 240 and/or a wireless carrier system that can be implemented using various data processing equipment, communication towers, etc.

Manager 210 may be hosted by a computing device and may include one or more computer programs executed by the computing device for centralized management of system 200. In one implementation, the manager 210 may comprise various interfaces, including administrative interface, reporting interface, and/or application programming interface (API) to communicate with nodes 220A-B, as well as to user portals, databases, directory servers and various other components, which are omitted from FIG. 2 for clarity. Manager 210 may interact with one or more computing devices to perform time recording and synchronization determination. In the example shown in FIG. 2, manager 210 may include a time recording component 112, an analysis component 114, and a synchronization component 116. Time recording component 112 may calculate the time required to have a container image ready for use. Analysis component 114 may determine whether the time satisfies a threshold criterion. Synchronization component 116 may perform a synchronization operation or prevent a synchronization operation for the container image identified by the determination of whether the time satisfies a threshold criterion.

Nodes 220A-B may comprise one or more computing devices with one or more processors communicatively coupled to memory devices and input/output (I/O) devices. Although nodes 220A-B comprise a computing device, the term “node” may refer to a computing device (e.g., physical machine), a virtual machine, or a combination thereof. Each of the nodes 220A-B may provide one or more levels of virtualization such as hardware level virtualization, operating system level virtualization, other virtualization, or a combination thereof. The hardware level virtualization may involve a hypervisor (e.g., virtual machine monitor) that emulates portions of a physical system and manages one or more virtual machines. In contrast, operating system level virtualization may include a single operating system kernel that manages multiple isolated virtual containers. Each virtual container may share the kernel of the underlying operating system without requiring its own kernel. In one example, the nodes 220A-B may include the computer system 100 of FIG. 1.

In the example of FIG. 2, node 220A (or 220B) may provide operating system level virtualization by running a computer program that provides computing resources to one or more containers 121A, 122A, 123A (or 121B, 122B, 123B), which is described similarly with respect to FIG. 1. In some implementations, the computing resources are often located in a data center. Users can interact with applications executing on the cloud-based nodes using client computer systems via corresponding web browser applications. In some implementations, the web browser applications may include an application interface (e.g., Crane™) that can make the content of the image repositories available to clients. Operating system 201A (or 201B) may include an operating system virtualizer that may provide containers 121A, 122A, 123A (or 121B, 122B, 123B) with access to computing resources, which is described similarly with respect to FIG. 1. Each of the containers 121A, 122A, 123A (or 121B, 122B, 123B) may be same as or similar to the containers 121, 122, 123 described with respect to FIG. 1.

In the example as shown in FIG. 2, the node 220A (or 220B) includes an agent 129A (or 129B). In one example, manage 210 may receive data 213 (e.g., container data) from an agent 129A (or 129B) that has access to data of the containers. In some implementations, manage 210 may build one or more container images in view of the data 213 of the containers. Agent 116 may be a computer program that inspects the containers. Agent 129A (or 129B) may execute as one or more user space processes, kernel processes, or a combination thereof on any node with access to executable content of the container. The node that execute agent 129A (or 129B) may be the same node that is executing the container (e.g., node 220A) or a different node. Agent 129A (or 129B) may be installed within or managed by a virtual machine, hypervisor, a host operating system, other computer program, or a combination thereof.

Image repository 230 may be any data store that is capable of storing one or more images, storage metadata, and storage lease information. The images may include container images, virtual machine images, disk images, other images, or a combination thereof. Image repository 230 may include block-based storage devices, file-based storage devices, other storage device, or a combination thereof. Block-based storage devices may provide access to consolidated block-based (e.g., block-level) data storage and may include one or more devices (e.g., Storage Area Network (SAN) devices). Block-based storage devices may be accessible over a network and may appear to an operating system of a computing device as locally attached storage. File-based storage devices may provide access to consolidated file-based (e.g., file-level) data storage using one or more data storage devices (e.g., Network Attached Storage (NAS) devices) that may be accessible over a network. In one example, a secondary storage with image repository 230 may employ block-based storage and the images, storage metadata, and storage lease may be provided by respective logical volumes. In another example, the secondary storage with image repository 230 may employ file-based storage and the images, storage metadata, and storage lease may be provided by one or more respective files. In the example shown in FIG. 2, image repository 130 includes container images 132A-C.

Container images 132A-C may include one or more computer programs along with a filesystem that contains the computer code, runtime, system tools, system libraries, other data, or a combination thereof to support the execution of a service within a container on node 220A. The container images 132A-C may not include an operating system but may be loaded and run by an operating system virtualizer that is part of operating system 201A of node 220A. Each of the container images 132A-C may include one or more data structures for storing and organizing information that may be used by node 120A to provide a computing service. The information within container images 132A-C may indicate the state of the image and may include computer code (e.g., machine code), configuration information (e.g., settings), or content information (e.g., file data, record data). Each of the container images 132A-C may be capable of being loaded onto node 220A and may be executed to provide one or more services.

In one implementation, container images 132A-C may be built using a Docker™ tool and is referred to as a Docker image. In other implementations, container images 132A-C may be built using other types of containerization technologies, for example, using an image build system (not shown) of system 200. The image build system may be provided on components hosted by cloud, on a server device external to the cloud, or even run on nodes. The image build system may generate a container image for an application or a service by combining pre-existing ready-to-run application image corresponding to core functional components of the application (e.g., a web framework, database, etc.) with source code specific to the application provided by the user. The resulting container image may be pushed to an image repository 230 for subsequent use in launching instances of the container images for execution. Upon receiving a command identifying specific data (e.g., application data and files used to initialize an application on the cloud), a cloud provider may retrieve the corresponding data from the image repository 230, creates an instance of it, and loads it to a host for execution by nodes. The command may be received from the cloud provider, or a user (e.g., a system administrator) via a console computer or a client machine. The image repository 230 may represent a single data structure or multiple data structures (databases, repositories, files, etc.) residing on one or more mass storage devices, such as magnetic or optical storage based discs, solid-state-drives (SSDs) or hard drives.

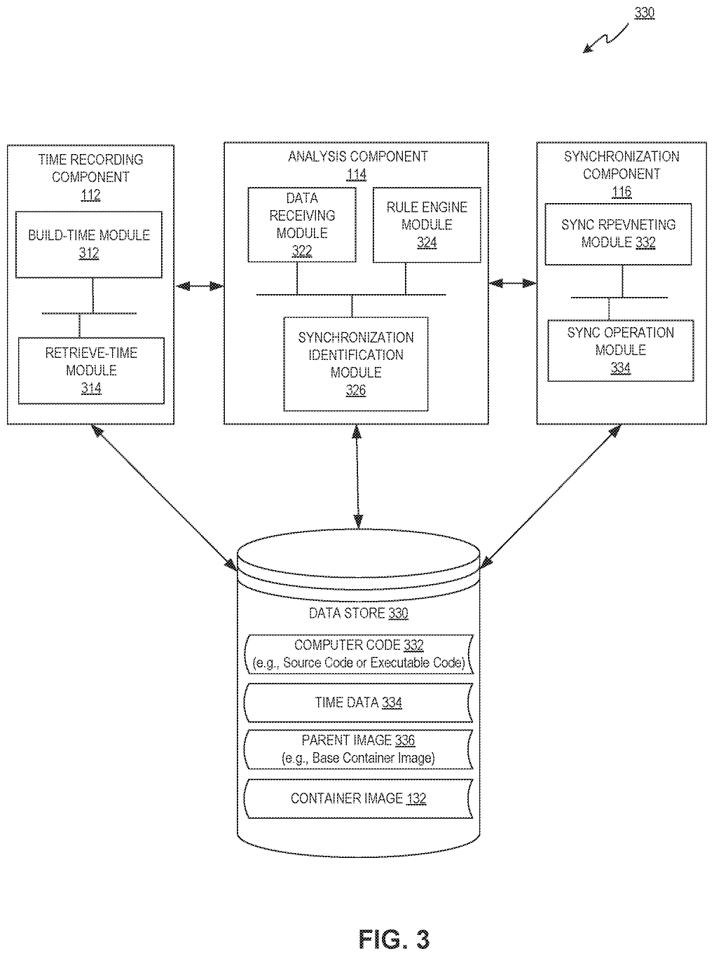

FIG. 3 is a block diagram illustrating example container management system 300, in accordance with one or more aspects of the present disclosure. The system 300 may be the same or similar to container management component 132 of FIG. 1 and/or manager 210 of FIG. 2. The components, modules, or features discussed in regards to system 300 may be consolidated to container management component 132, consolidated to manager 210, or be spread in any manner across both entities. More or fewer components may be included without loss of generality. For example, two or more of the components or portions of the components may be combined into a single component, or one of the components may be divided into two or more modules. In one implementation, one or more of the modules may be executed by different processing devices on different computing devices (e.g., different server computers). In the example shown in FIG. 3, system 300 may include a time recording component 112, an analysis component 114, a synchronization component 116, and a data store 330.

The time recording component 112 may calculate the time required to have a container image ready for use. The time recording component 112 may calculate the container image readiness time based on the information characterizing the container image availability for use. For example, as described in details below, if the container management engine builds the container image without using externally retrieved details (i.e., all code required to build the container image is available locally with respect to the container engine), the time recording component 112 may calculate the time as including only the local building time (e.g., CPU time). In another example, as described in details below, if a container engine builds the container image using remotely, with respect to the container engine, stored layers, and in such case, the time recording component 112 may calculate the time as including the building time (e.g., CPU time) and the retrieving time (e.g., access time and network-connecting time). In yet another example, as described in details below, if a container engine retrieves the container image rather than builds the container image, the time recording component 112 may calculate the time as including the access time and the network connecting time. In some embodiments, the time recording component 112 may include build-time module 312 and retrieve-time module 314.

Container image 132 may include the executable code of one or more processes of a particular service along with system libraries and/or data that support execution of the service within a container. Container image 132 may be capable of being initiated by a computing device (e.g., node) and may be loaded to perform one or more processes of a service. Container image 132 may contain no operating system or kernel libraries, and may be loaded and run by an existing operating system. Container image 132 may include one or more data structures for storing and organizing information in a format that can be interpreted by the operating system and executed by a processing device to provide the service.

The format of container image 132 may be based on any open standard, proprietary format, other format, or a combination thereof. The information within container image 132 may indicate the state of the image and may include executable information (e.g., machine code), configuration information (e.g., settings), or content information (e.g., file data, record data). In one example, container image 132 may include textual data that indicates the name, tag, and architecture of the image and may also include one or more data structures representing one or more layers of the image. The data structures may include schema version data, index data (e.g., digest data or hash data) of filesystem objects, and history data indicating one or more parent or child layers. In one example, the format may be based on a docker image manifest (e.g., docker image manifest V2, Schema 1), an open container initiative (OCI) specification, other container format, or a combination thereof.

Container image 132 may represent a chain of layers that when run as a container includes one or more copy-on-write (COW) volumes (which may also be referred to as “layers”). From the perspective of the container, the layers may appear as a single filesystem. Initially, the topmost layer may be a raw or COW volume, which may be made read-only before the initialization of the container image as a container. An attempt to write to the filesystem by the container may modify the image or may trigger adding a new COW volume (“layer”) to the volume chain. The top layer (e.g., new volume) may store disk blocks or files that have been modified or newly created by the container processes after the previous volume (“layer”) has been made read-only. One or more volumes may be added to the volume chain. In some implementations, making the previous volume read-only (e.g., responsive to receiving a command via an administrative interface) triggers adding of a new COW volume.

Build-time module 312 may enable a container engine that builds the container image to record the total time for building the container image and use the total time as the time required to have the container image ready for use. Building container image 132 may involve one or more operations that copy the computer code of one or more processes of a service into container image 132. In one example, the computer code may be copied from a version management control application (e.g., GIT) by executing RUN GIT clone path/to/src.git. In another example, the computer code may be copied using an operating system copy operation. In yet another example, the computer code may be made accessible to the container without executing a copy operation by mounting the storage location of the computer code.

Building container image 132 may involve generating or using a build file, which may be referred to as an instruction file, an assembly file, a docker file, other file, or a combination thereof. The build file may include textual data, binary data, other data, or a combination thereof. In one example, the build file may be a text document that contains instructions (e.g., command line commands) that are interpreted by a container image creation service (e.g., docker service) to assemble a container image. Each instruction may correspond to a layer that will be associated with or included within the container image.

In some embodiments, the container engine builds the container image without using details retrieved externally, i.e., all code required to build the container image is available locally with respect to the container engine, and in such case, the total time for building includes only the local building time (e.g., CPU time). For example, the container engine may build a single-layer container image, and the total time for building is the time for creating the single layer of the container image. In another example, the container engine may build a multiple-layer container image, and the total time for building is the time for creating each layer, including parent layer and base layer, of the container image.

In some embodiments, the container engine builds the container image based on layer(s) stored remotely with respect to the container engine, and in such case, the total time for building includes the building time (e.g., CPU time) and the retrieval time (e.g., access time and network-connecting time). For example, the container engine may identify an image in an image repository (e.g., image repository 230) that will function as the parent image. The container engine may then access the parent image and modify the parent image to create a container image 132. The parent image may be a pre-built template image and may be identical to a base image or may be a modified version of the base image. A template image may refer to an image that establishes or serves as a pattern or model for a container image. A base image may refer to an image that serves an a bottom or foundation of a container image. For example, the base image may be publically available and may correspond directly to a particular operating system (e.g., Fedora®, Windows®, Mac®).

The retrieve-time module 314 may enable a container engine that retrieves the container image to record the total time for retrieving the container image and use the total time as the time required to have the container image ready for use. In some examples, the container engine retrieves a container image from a device that is connected through a network, and in such case, the total time includes the time required to access the container image and the time required to have a successful network connection for data communication.

The analysis component 114 may determine whether the time satisfies a threshold criterion. In some embodiments, the analysis component 114 may include a data receiving module 322, a rules engine module 324, and a synchronization identification module 326.

Data receiving module 322 may receive data of the calculated time from the time recording component 112. The data of the calculated time (e.g., time data 334) may be stored in a data store 330.

Rules engine module 324 may analyze the data of the calculated time in view of one or more rules. The rules engine may apply a set of rules to the data. The rules may be stored in a data structure (e.g., a CSV format). The rules may provide one or more criteria for performing a synchronization operation that stores the container image in a persistent storage. In some embodiments, the rules may specify a threshold criterion for the synchronization operation that stores the container image in a persistent storage. In one example, the threshold criterion may provide an instruction to perform the synchronization operation to store the container image in a persistent storage when the calculated time exceeds a threshold value, and provide an instruction to avoid the synchronization operation when the calculated time does not exceed a threshold value. In some implementations, rule engine module 324 may utilize a fixed threshold value, which may be determined according to statistical information characterizing the image readiness time and the performance of storing the container image in a persistent storage. In another example, the threshold criterion may provide an instruction to perform the synchronization operation that stores the container image in a persistent storage when the container image is built rather than retrieved for use (e.g., the data of the calculated time is obtained from the build-time module 312, an indication (e.g., a flag) representing a container image is built is added as a metadata to data of the calculated time), and provide an instruction to avoid the synchronization operation when the container image is retrieved for use (e.g., the data of the calculated time is obtained from the retrieve-time module 314, an indication (e.g., a flag) representing a container image is retrieved is added as a metadata to data of the calculated time). In yet another example, the threshold criterion may provide an instruction to perform the synchronization operation that stores the container image in a persistent storage when the container image is created including user-customized elements (e.g., an indication (e.g., a flag) representing customization is added as a metadata to data of the calculated time), and provide an instruction to avoid the synchronization operation when the container image is created not including user-customized elements (e.g., an indication (e.g., a flag) representing non-customization is added as a metadata to data of the calculated time). In yet another example, the threshold criterion may provide an instruction to perform the synchronization operation that stores the container image in a persistent storage when the container image is one of a cluster of container images (e.g., an indication (e.g., a flag) representing cluster is added as a metadata to data of the calculated time), and provide an instruction to avoid the synchronization operation when the container image is not in a cluster of container images (e.g., an indication (e.g., a flag) representing non-cluster is added as a metadata to data of the calculated time). In yet another example, the threshold criterion may include one or more threshold criteria described above.

Rules engine module 324 may enable the system to determine whether the calculated time satisfies a threshold criterion for a synchronization operation to store the container image in a persistent storage. In one example, rules engine module 314 may enable the system to determine whether the calculated time exceeds a threshold value, which is included in the rule as an instruction whether to perform the synchronization operation to store the container image in a persistent storage. In another example, rules engine module 314 may enable the system to determine the existence of an indication that is added to the data of the calculated time, which is included in the rule as an instruction whether to perform the synchronization operation to store the container image in a persistent storage. The indication may be a flag representing the container image is built or retrieved, a flag representing the container image contains customized elements or not, or a flag representing the contained image is one of a cluster of contained images or not.

Synchronization identification module 326 may identify the container image that is determined by the rule engine module 324 for performing a synchronization operation to make the container image saved in a persistent storage. The synchronization identification module 326 may also identify the container image that is determined by the rule engine module 324 for not performing (i.e., preventing) a synchronization operation that makes the container image saved in a persistent storage. The identification of container image may be different based on whether performing the synchronization operation is in default.

In some embodiments, the synchronization operation to make the container image saved in a persistent storage is performed by default, and in such case, responsive to determining that the calculated time does not exceed a threshold value, the synchronization identification module 326 may identify the container image for avoiding a synchronization operation that makes the container image saved in a persistent storage. In some embodiments, the synchronization operation to make the container image saved in a persistent storage is not performed by default, and in such case, responsive to determining that the calculated time exceeds a threshold value, the synchronization identification module 326 may identify the container image for performing a synchronization operation that makes the container image saved in a persistent storage.

In some embodiments, the synchronization operation to make the container image saved in a persistent storage is performed by default, and in such case, responsive to determining that an indication exits indicating that the container image is retrieved (e.g., the data of the calculated time is obtained from the retrieve-time module 314), the synchronization identification module 326 may identify the container image for preventing a synchronization operation that makes the container image saved in a persistent storage. In some embodiments, the synchronization operation to make the container image saved in a persistent storage is not performed by default, and in such case, responsive to determining that t an indication exits indicating that the container image is built (e.g., the data of the calculated time is obtained from the build-time module 312), the synchronization identification module 326 may identify the container image for performing a synchronization operation that makes the container image saved in a persistent storage.

In some embodiments, the synchronization operation to make the container image saved in a persistent storage is performed by default, and in such case, responsive to determining that the calculated time has a flag indicating customization, the synchronization identification module 326 may identify the container image for performing a synchronization operation that makes the container image saved in a persistent storage. In some embodiments, the synchronization operation to make the container image saved in a persistent storage is not performed in default, and in such case, responsive to determining that the calculated time does not have a flag indicating customization, the synchronization identification module 326 may identify the container image for preventing a synchronization operation that makes the container image saved in a persistent storage.

Synchronization component 116 may perform a synchronization operation or prevent a synchronization operation for the container image identified by synchronization identification module 326. In some embodiments, synchronization component 116 may include a sync preventing module 332 and a sync operation module 334.

Sync preventing module 332 may prevent a synchronization operation that makes a container image saved in a persistent storage for the container image identified by synchronization identification module 326. For example, sync preventing module 332 may prevent the synchronization operation by sending an instruction to stop the execution of syncfs( ) operation.

Sync operation module 334 may perform a synchronization operation that makes a container image saved in a persistent storage for the container image identified by synchronization identification module 326. For example, sync operation module 334 may perform the synchronization operation by implementing a system call for syncfs( )) operation.

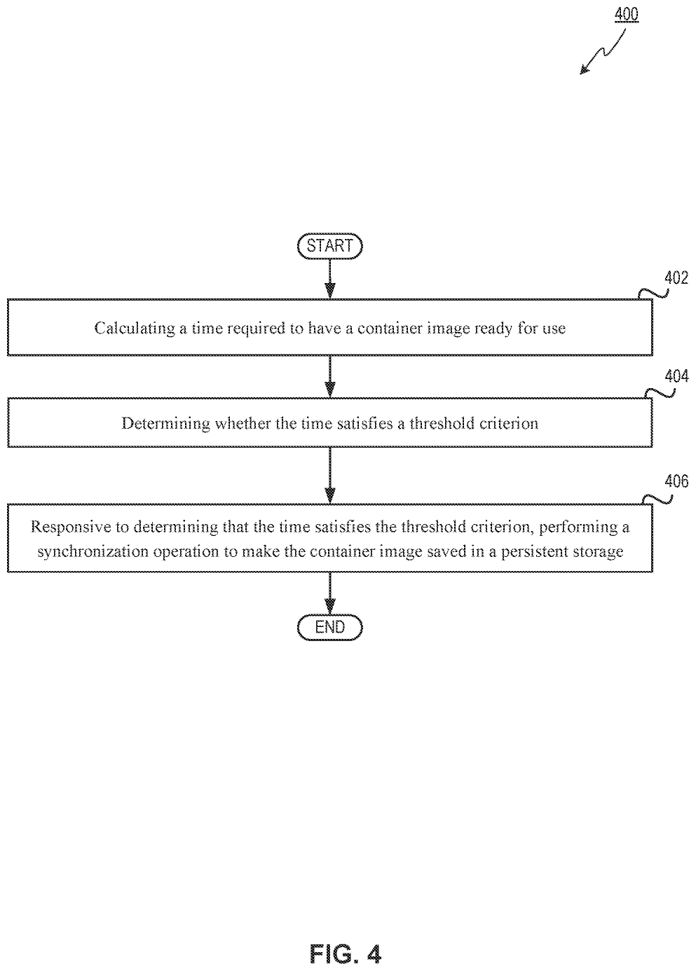

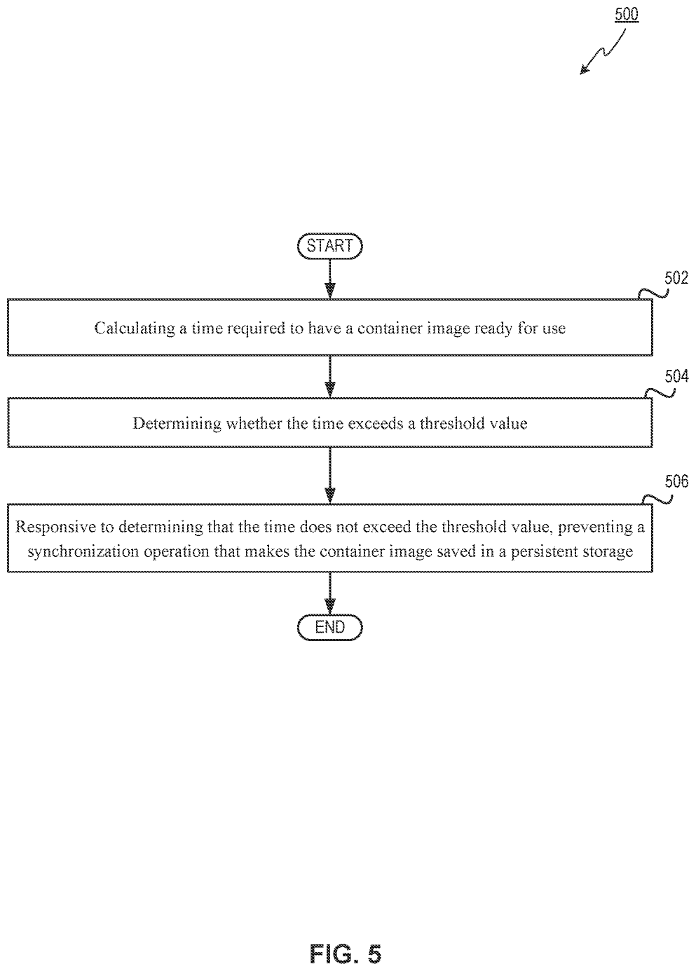

FIGS. 4 and 5 depict flow diagrams for illustrative examples of methods 400 and 500 for adaptively performing a synchronization operation for a container image based on time. Methods 400 and 500 may be performed by processing devices that may comprise hardware (e.g., circuitry, dedicated logic, programmable logic, microcode, etc.), executable code (such as is run on a general purpose computer system or a dedicated machine), or a combination of both. Methods 400 and 500 and each of their individual functions, routines, subroutines, or operations may be performed by one or more processors of the computer device executing the method. In certain implementations, methods 400 and 500 may each be performed by a single processing thread. Alternatively, methods 400 and 500 may be performed by two or more processing threads, each thread executing one or more individual functions, routines, subroutines, or operations of the method. In an illustrative example, the processing threads implementing methods 400 and 500 may be synchronized (e.g., using semaphores, critical sections, and/or other thread synchronization mechanisms). Alternatively, the processes implementing methods 400 and 500 may be executed asynchronously with respect to each other.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media. In one implementation, methods 400 and 500 may be performed by container management component 132 of FIG. 1, manager 210 of FIG. 2, and/or system 300 of FIG. 3.

Referring to FIG. 4, at block 402, the processing device may calculate the time required to have a container image ready for use. Based on whether and how the container image is available for use, the processing device may calculate the time differently. In some implementations, the processing device may enable a container engine that builds the container image to record the total time for building the container image and use the total time as the time required to have the container image ready for use. In one example, the container engine builds the container image without using details retrieved externally, i.e., all code required to build the container image is available locally with respect to the container engine, and in such case, the total time for building includes only the local building time. In another example, the container engine builds the container image based on layer(s) retrieved remotely with respect to the container engine, and in such case, the total time for building includes the building time and the retrieving time. In some implementations, the processing device may enable a container engine that retrieves the container image to record the total time for retrieving the container image and use the total time as the time required to have the container image ready for use. For example, the container engine retrieves a container image from a device that is connected through a network, and in such case, the total time includes the access time and the network connecting time.

At block 404, the processing device may determine whether the time calculated for the container image satisfies a threshold criterion. The processing device may analyze the data of the calculated time in view of one or more criteria for performing an operation. The one or more criteria may be derived from an IT administrator, service designer, end user, other source, or a combination thereof. The one or more criteria may be stored in a data structure (e.g., a CSV format). In one example, the processing device may determine whether the calculated time exceeds a threshold value to determine whether to perform the synchronization operation to make the container image saved in a persistent storage. In another example, the processing device may determine whether an indication exists indicating whether the container image is built or retrieved (e.g., whether the data of the calculated time is obtained from the build-time module 312 or the retrieve-time module 314), to determine whether to perform the synchronization operation to make the container image saved in a persistent storage. In yet another example, the processing device may determine whether the container image is customized, for example, by determine whether an indication (e.g., a flag) representing the customization exists, in the rule as an instruction whether to perform the synchronization operation to make the container image saved in a persistent storage.

At block 406, the processing device may perform a synchronization operation to make the container image saved in a persistent storage, responsive to determining that the time calculated for the container image satisfies the threshold criterion. In one example, responsive to determining that the time exceeds the threshold value, the processing device may perform a synchronization operation that makes the container image saved in a persistent storage. In another example, responsive to determining that an indication exists indicating that the container image is built (e.g., the data of the calculated time is obtained from the build-time module 312), the processing device may perform a synchronization operation that makes the container image saved in a persistent storage.

The processing device may also prevent performing a synchronization operation that makes the container image saved in a persistent storage, responsive to determining that the time calculated for the container image does not satisfy the threshold criterion. In one example, responsive to determining that the time does not exceed the threshold value, the processing device may prevent performing a synchronization operation that makes the container image saved in a persistent storage. In another example, responsive to determining an indication exists indicating that the container image is retrieved (e.g., the data of the calculated time is obtained from the retrieve-time module 314), the processing device may prevent performing a synchronization operation that makes the container image saved in a persistent storage. Responsive to completing the operations described herein above with references to block 406, the method may terminate.

Referring to FIG. 5, at block 502, the processing device may calculate the time required to have a container image ready for use, which may be the same as or similar to the block 402. At block 504, the processing device may determine whether the time calculated for the container image exceeds a threshold value. The threshold value may be derived from an IT administrator, service designer, end user, other source, or a combination thereof. The threshold value may be stored in a data structure (e.g., a CSV format).

At block 506, the processing device may prevent performing a synchronization operation that makes the container image saved in a persistent storage, responsive to determining that the time calculated for the container image does not exceed the threshold value. The prevention step is especially useful when the synchronization operation that makes the container image saved in a persistent storage is performed in default. Responsive to completing the operations described herein above with references to block 506, the method may terminate.

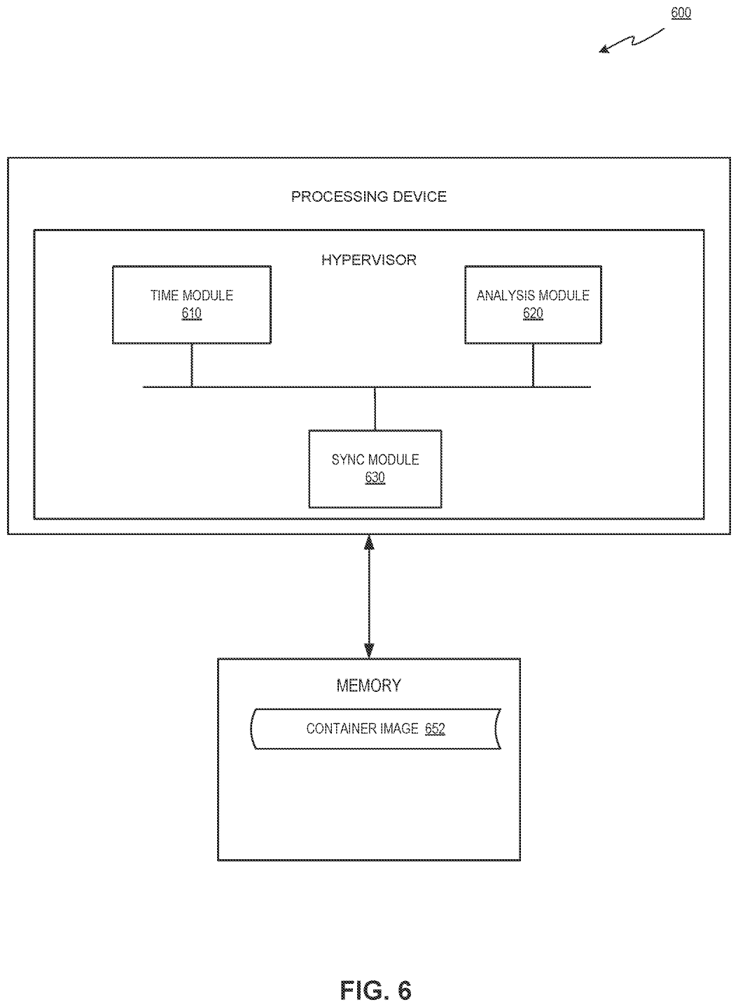

FIG. 6 depicts a block diagram of a computer system 600 operating in accordance with one or more aspects of the present disclosure. Computer system 600 may be the same or similar to computing system 100 of FIG. 1 and/or system 200 of FIG. 0.2 and may include one or more processing devices and one or more memory devices. In the example shown, computer system 600 may include a time module 610, an analysis module 620, and a sync module 630.

Time module 610 may calculate the time required to have a container image (e.g., container image 652) ready for use. Based on whether and how the container image is available for use, time module 610 may calculate the time differently. In some implementations, time module 610 may enable a container engine that builds the container image to record the total time for building the container image and use the total time as the time required to have the container image ready for use. In one example, the container engine builds the container image without using details retrieved externally, i.e., all code required to build the container image is available locally with respect to the container engine, and in such case, the total time for building includes only the local building time. In another example, the container engine builds the container image based on layer(s) retrieved remotely with respect to the container engine, and in such case, the total time for building includes the building time and the retrieving time. In some implementations, time module 610 may enable a container engine that retrieves the container image to record the total time for retrieving the container image and use the total time as the time required to have the container image ready for use. For example, the container engine retrieves a container image from a device that is connected through a network, and in such case, the total time includes the access time and the network connecting time.

Analysis module 620 may determine whether the time calculated for the container image satisfies a threshold criterion. Analysis module 620 may analyze the data of the calculated time in view of one or more criteria for performing an operation. The one or more criteria may be derived from an IT administrator, service designer, end user, other source, or a combination thereof. The one or more criteria may be stored in a data structure (e.g., a CSV format). In one example, analysis module 620 may determine whether the calculated time exceeds a threshold value to determine whether to perform the synchronization operation to make the container image saved in a persistent storage. In another example, analysis module 620 may determine whether the container image is built or retrieved, to determine whether to perform the synchronization operation to make the container image saved in a persistent storage. In yet another example, analysis module 620 may use the combination of above two examples to determine whether to perform the synchronization operation to make the container image saved in a persistent storage.

Sync module 630 may perform a synchronization operation to make the container image saved in a persistent storage, responsive to determining that the time calculated for the container image satisfies the threshold criterion. In one example, responsive to determining that the time exceeds the threshold value, sync module 630 may perform a synchronization operation that makes the container image saved in a persistent storage. In another example, responsive to determining that the container image is built, sync module 630 may perform a synchronization operation that makes the container image saved in a persistent storage.

Sync module 630 may also prevent performing a synchronization operation that makes the container image saved in a persistent storage, responsive to determining that the time calculated for the container image does not satisfy the threshold criterion. In one example, responsive to determining that the time does not exceed the threshold value, sync module 630 may prevent performing a synchronization operation that makes the container image saved in a persistent storage. In another example, responsive to determining that the container image is retrieved, sync module 630 may prevent performing a synchronization operation that makes the container image saved in a persistent storage.

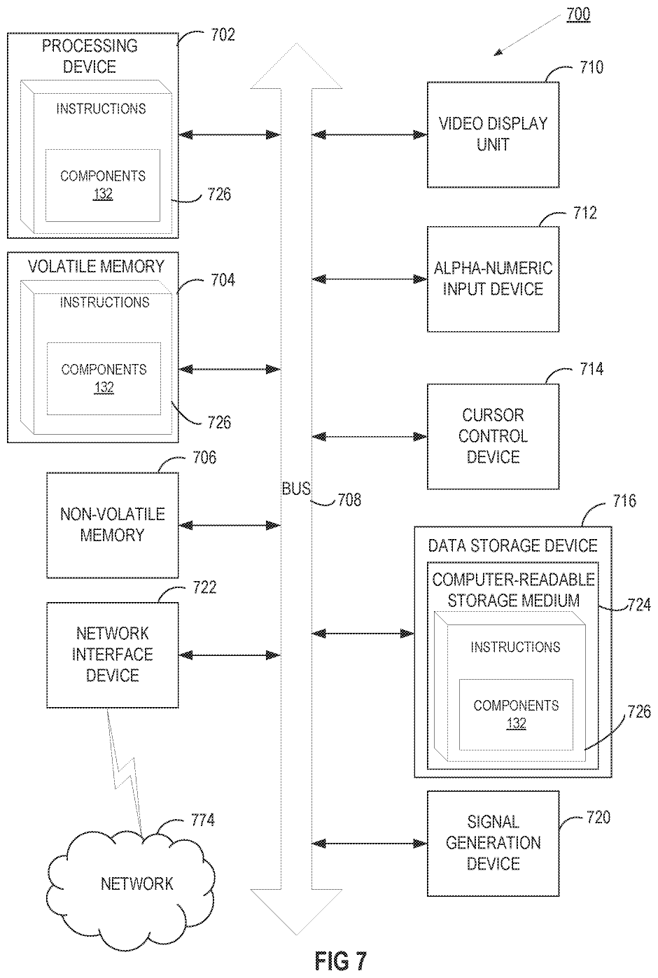

FIG. 7 illustrates a diagrammatic representation of a machine in the example form of a computer system 800 within which a set of instructions, for causing the machine to perform any one or more of the methodologies discussed herein, may be executed. In various illustrative examples, computer system 700 may correspond to computing system 100 of FIG. 1 or the system 200 of FIG. 2. In some implementations, the computer system 700 may support manifest list for multi-platform application container images.

The computer system 700 may be included within a data center that supports virtualization. Virtualization within a data center results in a physical system being virtualized using virtual machines to consolidate the data center infrastructure and increase operational efficiencies. A virtual machine (VM) may be a program-based emulation of computer hardware of the virtualized data center. For example, the VM may operate based on computer architecture and functions of computer hardware resources associated with hard disks or other such memory. The VM may emulate a physical computing environment, but requests for a hard disk or memory may be managed by a virtualization layer of a host machine to translate these requests to the underlying physical computing hardware resources. This type of virtualization results in multiple VMs sharing physical resources.

In certain implementations, computer system 700 may be connected (e.g., via a network, such as a Local Area Network (LAN), an intranet, an extranet, or the Internet) to other computer systems. Computer system 700 may operate in the capacity of a server or a client computer in a client-server environment, or as a peer computer in a peer-to-peer or distributed network environment. Computer system 700 may be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein for supporting manifest list for multi-platform application container images.

The computer system 700 includes a processing device 702, a main memory 704 (e.g., read-only memory (ROM), flash memory, dynamic random access memory (DRAM) (such as synchronous DRAM (SDRAM) or DRAM (RDRAM), etc.), a static memory 706 (e.g., flash memory, static random access memory (SRAM), etc.), and a data storage device 716, which communicate with each other via a bus 708.

Processing device 702 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 702 may also be one or more special-purpose processing devices such as an application specific integrated circuit (ASIC), a field programmable gate array (FPGA), a digital signal processor (DSP), network processor, or the like. The processing device 702 is to execute the processing logic 726 for performing the operations and steps discussed herein.

The computer system 700 may further include a network interface device 722 communicably coupled to a network 725. The computer system 700 also may include a video display unit 710 (e.g., a liquid crystal display (LCD) or a cathode ray tube (CRT)), an alphanumeric input device 712 (e.g., a keyboard), a cursor control device 714 (e.g., a mouse), and a signal generation device 716 (e.g., a speaker).

Instructions 726 may reside, completely or partially, within volatile memory 704 and/or within processing device 702 during execution thereof by computer system 700, hence, volatile memory 704 and processing device 702 may also constitute machine-readable storage medium 724. The instructions 726 may also implement the component 132 to support container image management.

Data storage device 716 may include a computer-readable storage medium 724 (e.g., a non-transitory computer-readable storage medium) on which may store instructions 726 encoding any one or more of the methods or functions described herein, including instructions for implementing method 400 of FIG. 4, and method 500 of FIG. 5.

The non-transitory machine-readable storage medium 724 may also be used to store instructions 726 to support manifest list for multi-platform application container images described herein, and/or a software library containing methods that call the above applications. While the machine-accessible storage medium 724 is shown in an example implementation to be a single medium, the term “machine-accessible storage medium” should be taken to include a single medium or multiple media (e.g., a centralized or distributed database, and/or associated caches and servers) that store the one or more sets of instructions. The term “machine-accessible storage medium” shall also be taken to include any medium that is capable of storing, encoding or carrying a set of instruction for execution by the machine and that cause the machine to perform any one or more of the methodologies of the disclosure. The term “machine-accessible storage medium” shall accordingly be taken to include, but not be limited to, solid-state memories, and optical and magnetic media.

It is to be understood that the above description is intended to be illustrative, and not restrictive. Many other implementations are apparent upon reading and understanding the above description. The scope of the disclosure should, therefore, be determined with reference to the appended claims, along with the full scope of equivalents to which such claims are entitled.

In the above description, numerous details are set forth. It is apparent, however, that the disclosure may be practiced without these specific details. In some instances, structures and devices are shown in block diagram form, rather than in detail, in order to avoid obscuring the disclosure.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “separating”, “generating”, “clustering”, “publishing”, “identifying” “determining”, “combining”, “providing” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems appears as set forth in the description below. In addition, the disclosure is not described with reference to any particular programming language. It is appreciated that a variety of programming languages may be used to implement the teachings of the disclosure as described herein.

The disclosure may be provided as a computer program product, or software, that may include a machine-readable medium having stored thereon instructions, which may be used to program a computer system (or other electronic devices) to perform a process according to the disclosure. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical or other form of propagated signals (e.g., carrier waves, infrared signals, digital signals, etc.)), etc.

It is to be understood that the above description is intended to be illustrative, and not restrictive. Many other implementation examples are apparent upon reading and understanding the above description. Although the disclosure describes specific examples, it is recognized that the systems and methods of the disclosure are not limited to the examples described herein, but may be practiced with modifications within the scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

What is claimed is:

1. A method comprising:
calculating, by a processing device, a time required to have a container image ready for use;
determining whether the time satisfies a threshold criterion; and
responsive to determining that the time satisfies the threshold criterion, performing a synchronization operation that stores the container image in a persistent storage.

2. The method of claim 1, further comprising:
responsive to determining that the time does not satisfy the threshold criterion, avoiding the synchronization operation.

3. The method of claim 1, wherein calculating the time further comprises obtaining a time for building the container image.

4. The method of claim 1, wherein calculating the time further comprises obtaining a time for retrieving the container image.

5. The method of claim 1, wherein determining whether the time satisfies a threshold criterion further comprises determining whether the time exceeds a threshold value.

6. The method of claim 1, wherein determining whether the time satisfies a threshold criterion further comprises determining whether the time is associated with one of: building the container image or retrieving the container image.

7. The method of claim 1, wherein determining whether the time satisfies a threshold criterion further comprises determining whether the time is associated with customizing the container image.

8. A system comprising:
a memory; and
a processing device, operatively coupled to the memory, to:
calculate, by a processing device, a time required to have a container image ready for use;
determine whether the time satisfies a threshold criterion; and
responsive to determining that the time satisfies the threshold criterion, perform a synchronization operation that stores the container image in a persistent storage.

9. The system of claim 8, wherein the processing device is further to, responsive to determining that the time does not satisfy the threshold criterion, avoid the synchronization operation.

10. The system of claim 8, wherein the processing device is further to: obtain a time for building the container image to be included in the time.

11. The system of claim 8, wherein the processing device is further to: obtain a time for retrieving the container image to be included in the time.

12. The system of claim 8, wherein the processing device is further to: determine whether the time exceeds a threshold value.

13. The system of claim 8, wherein the processing device is further to: determine whether the time is associated with one of: building the container image or retrieving the container image.

14. The system of claim 8, wherein the processing device is further to: determine whether the time is associated with customizing the container image.

15. A non-transitory computer-readable medium comprising instructions that, when executed by a processing device, cause the processing device to perform operations comprising:
calculating, by a processing device, a time required to have a container image ready for use;
determining whether the time exceeds a threshold value;
responsive to determining that the time exceeds the threshold value, performing a synchronization operation that stores the container image in a persistent storage.

16. The non-transitory computer-readable medium of claim 15, wherein the operations further comprise: responsive to determining that the time does not exceed he threshold value, avoiding the synchronization operation.

17. The non-transitory computer-readable medium of claim 15, wherein the threshold value is preset.

18. The non-transitory computer-readable medium of claim 15, wherein the operations further comprise: responsive to determining the time is associated with building the container image, performing the synchronization operation.

19. The non-transitory computer-readable medium of claim 15, wherein the operations further comprise: responsive to determining that the time is associated with customizing the container image, performing the synchronization operation.

20. The non-transitory computer-readable medium of claim 15, wherein the time comprises a build time and/or a retrieve time.
